(19) United States
(12) Patent Application Publication
(10) Pub. No.: US 2025/0202784 A1
(43) Pub. Date: Jun. 19, 2025

(54) NETWORK DATA REPLICATION FOR DIGITAL TWIN USING ARTIFICIAL INTELLIGENCE

(71) Applicant: Cisco Technology, Inc., San Jose, CA (US)

(72) Inventors: Josh P. Halley, Moosburg an der Isar (DE); Asier Arlegui Lacunza, Sant Cugat Del Valles (ES)

(21) Appl. No.: 18/540,997

(22) Filed: Dec. 15, 2023

(51) Int. Cl. H04L 43/062; H04L 41/16; H04L 43/026

(52) U.S. Cl. CPC H04L 43/062; H04L 41/16; H04L 43/026

(57) ABSTRACT

A method to select traffic flows for replication and transmission to a digital twin. The method may include operating a production communications network, monitoring traffic flows through the production communications network, training, based on the traffic flows, an artificial intelligence system to identify selected traffic flows, replicating the selected traffic flows to obtain replicated selected traffic flows, and forwarding the replicated selected traffic flows to a digital twin of the production communications network for analysis.

### TECHNICAL FIELD

The present disclosure relates to operating a digital twin device or system and, more specifically, to selectively replicating network data that is passed to the digital twin device.

### BACKGROUND

Digital twin devices (or “digital twins”), which can be both hardware or software based, are replicas of physical devices and non-physical devices. For example, a digital twin can include a virtual replica and/or a physical replica of another device, which may be physical or non-physical. In a networking environment, digital twins can be used to model information systems, networks, network capabilities, and/or network devices for purposes of testing configuration changes, traffic loads, etc. for optimization, troubleshooting, validating, proving concepts, and/or predicting outcomes. To be an effective replica, a digital twin obtains sufficient network traffic flow information, such as control plane configuration and/or data plane traffic information, to meaningfully test and/or reflect operation of the source device or network being replicated. One of the challenges of operating a digital twin in a networking environment is to feed it relevant traffic that may be replicated from a production network that is being replicated.

### BRIEF DESCRIPTION OF THE DRAWINGS

FIG. 1 depicts a physical network and a digital twin, along with replication logic, according to an example embodiment.

FIG. 2 shows a process for training a model for replication logic, according to an example embodiment.

FIG. 3 shows how selected flows are replicated and passed to digital twin, according to an example embodiment.

FIG. 4 is a flowchart illustrating a series of operations that may be executed by replication logic and/or related functions or components, according to an example embodiment.

FIG. 5 is a block diagram of a computing device that may be configured to execute replication logic and perform the techniques described herein, according to an example embodiment.

### DETAILED DESCRIPTION

### Overview

A method to select traffic flows for replication and transmission to a digital twin is provided. The method may include operating a production communications network, monitoring traffic flows through the production communications network, training, based on the traffic flows, an artificial intelligence system to identify selected traffic flows, replicating the selected traffic flows to obtain replicated selected traffic flows, and forwarding the replicated selected traffic flows to a digital twin of the production communications network for analysis. In this context, analysis may include testing configurations, simulating scenarios, predicting network performance issues, among other possible analytics.

In another embodiment, a device is provided. The device includes an interface configured to enable network communications, a memory, and one or more processors coupled to the interface and the memory, and configured to operate a production communications network, monitor traffic flows through the production communications network, train, based on the traffic flows, an artificial intelligence system to identify selected traffic flows, replicate the selected traffic flows to obtain replicated selected traffic flows, and forward the replicated selected traffic flows to a digital twin of the production communications network for analysis.

### Example Embodiments

Network architectures are turning towards automated and standardized networks. Technical debt associated with legacy approaches are accelerating the transition towards automation and service-driven architectures that align with IT organization business goals.

Many IT organizations face a significant challenge in that, although they can create a digital twin to simulate their network architecture, they may often lack the ability to selectively replicate appropriately meaningful or consequential traffic that flows through their live network environment.

While a precise digital twin aims to reproduce the organization's network's nuanced behavior, achieving accurate testing, optimization, and security assessment within the digital twin environment can be challenging, especially as it is impractical to replicate all network traffic to be processed by the digital twin.

In this regard, and unlike some solutions that indiscriminately send “Internet Mix” (IMIX) or “Enterprise Mix” (EMIX) traffic through a digital twin, the embodiments described herein operate to incorporate “real” or “appropriately representative” traffic that aligns with the daily changes observed in organizations. The approach described herein is configured to generate a meaningful replica of the production network traffic without overloading the digital twin. Notably, the disclosed system is configured to intelligently select specific flows to be replicated and passed to the digital twin, based on operator defined objectives and business context of the customer or enterprise. Although just a small portion of the overall production traffic flows may be replicated to the digital twin, e.g., perhaps in a ratio of 1:50, that selected portion is configured to best represent, for purposes of digital twin analysis, the production traffic. This approach allows for ongoing and dynamic replication of real production traffic.

As will be explained more fully below, the disclosed system is configured to tailor the amount of bandwidth and traffic to be replicated in real-time and sent to the digital twin based on several factors, including, e.g., a digital twin profile.

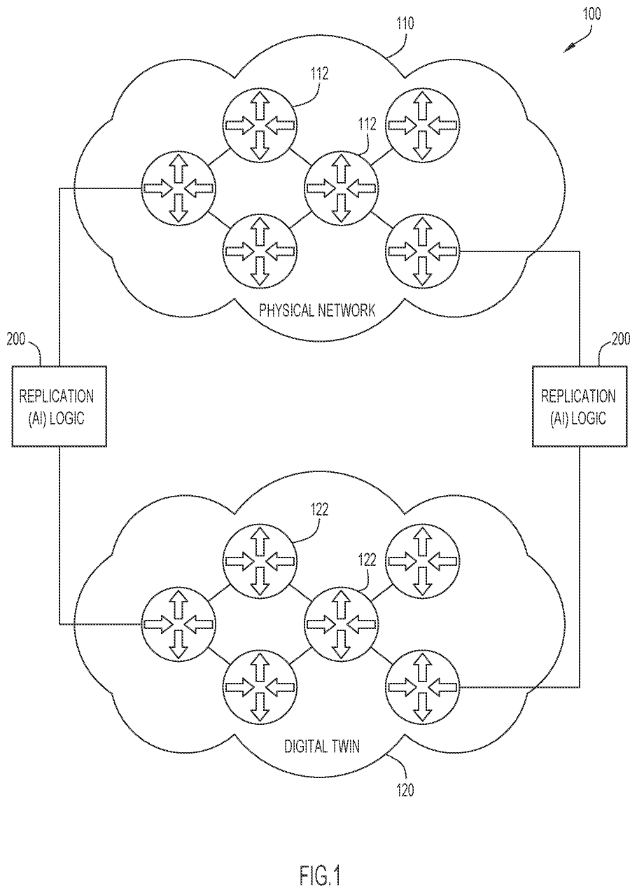

Reference is now made to FIG. 1, which depicts a system 100 including a physical network 110 including, e.g., a plurality of routers 112 (or any other physical or virtual network device), a digital twin 120, including corresponding, routers 122 (or other physical or virtual network device) or representations thereof, along with replication logic 200 according to an example embodiment. Physical network 110 may include any number of routers 112 (or other network device) that operate as, e.g., core, intermediate, or edge routers, or according to different network roles. Although not shown, those skilled in the art will appreciate that any number of other components, including client and/or server devices, which may be interconnected with routers 112 (or other network devices), may be included in physical network 110 as well.

Digital twin 120 may be implemented with hardware, software, or a combination thereof. In the depicted embodiment of FIG. 1, there is one-to-one correspondence between routers 112 and routers 122. However, those skilled in the art will appreciate that digital twin 120 may be configured to integrate the functionality of two or more routers 122 (or other network devices) into a singular entity, as long as that singular entity accurately simulates the functionality of the routers 112 that it intends to simulate.

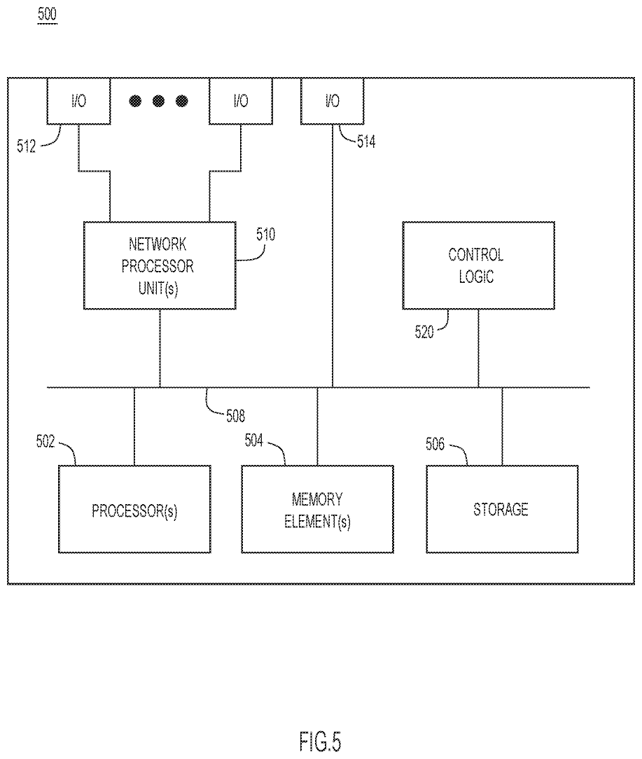

Replication logic 200 may include artificial intelligence (AI) and/or machine learning (ML) components that enable replication logic 200 to intelligently select which flows passing through physical network 110 should be replicated and passed to digital twin 120 for analysis. FIG. 5 (described later herein) shows one possible arrangement of a device that may implement replication logic 200. Replication logic 200 may be incorporated into, e.g., a router, switch, network device (e.g., firewall, load balancer, access point, wireless LAN controller), or other component(s) within physical network 110.

Replication logic 200 may be configured to intelligently select, using AI-training, specific flows to be replicated to digital twin 120, based, e.g., on operator defined objectives and business context of a user or customer.

In accordance with an embodiment, replication logic 200 is configured to intercept traffic (perhaps in real time or near-real time) in network devices, directly from physical network 110, empowering replication logic 200 to intelligently replicate data flows in near-real time. This functionality enables near-instant network simulation and analysis, offering valuable insights for efficient network operation and management. By harnessing this capability, an operator of physical network 110 can make informed decisions to optimize their network.

Replication logic 200 effectively manages and adjusts throughput within the virtual architecture of digital twin 120. This capability enables digital twin 120 to operate efficiently without becoming overwhelmed by excessive data or traffic. That is, by intelligently adjusting throughput, digital twin 120 can better maintain healthy processing (CPU) and memory capacity or usage in the infrastructure hosting digital twin 120.

In an embodiment, replication logic 200 is responsive to feedback from digital twin 120 to send data from physical network 110 to digital twin 120. Replication logic 200 may develop a profile of an environment of digital twin 120 by considering factors such as the scaling of a software replica in terms of CPU, memory, and bandwidth, as well as the mix of virtual and physical components hosting digital twin 120. This digital twin profile provides insights into, e.g., a maximum allowable throughput that may be transmitted through the architecture of digital twin 120 without exceeding system limits and disrupting the topology. The digital twin profile may be utilized in subsequent activities, such as AI/ML training, to generate transmission profiles for optimal performance.

As noted, replication logic 200 may employ AI/ML training methods to create intelligent decisions for the traffic flows that are to be transmitted to digital twin 120 based on the digital twin profile, as well as on historical factors over time.

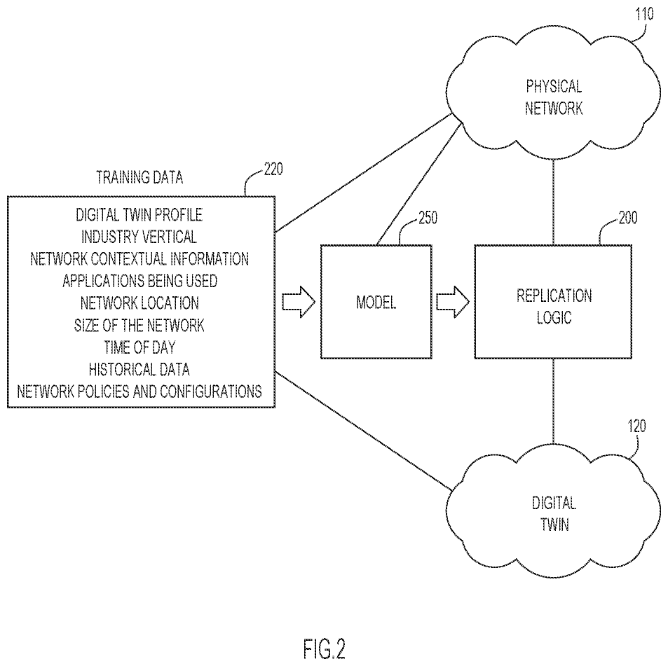

FIG. 2 shows a process for training a model 250 for replication logic 200, according to an example embodiment. As shown, training data 220 is supplied to model 250 that is trained to intelligently select flows passing through physical network 110 that are to be replicated and processed by digital twin 120. Model 250 may be implemented as, e.g., a neural network. Model 250 may be incorporated into replication logic 200 or be deployed separately, as shown. In one possible embodiment, replication logic 200 may take advantage of, e.g., embedded container architectures.

Data training in the system may be continuous, with reinforcement achieved by reintroducing proven effective patterns. This iterative process is used in machine learning, ensuring model 250 adapts to new data while maintaining accuracy by relying on established successful patterns. It keeps model 250 effective in evolving environments and changing conditions.

Supervised learning techniques may be applied for environments that have more special data stream requirements and needs, such as selection of Internet of Things (IoT) data streams in industrial environments and healthcare systems. This approach raises the ability to preempt potential issues caused by certain traffic types, and can diminish the potential that new rules and policies cause service disruption.

Referring again to FIG. 2, to train the model 250 to intelligently select traffic flows to be replicated to digital twin 120, the following training data 220 or inputs may be provided.

Profile of digital twin 120: The digital twin profile may define, e.g., a maximum allowable throughput that can be transmitted through the architecture of digital twin 120 without exceeding predetermined system limits (CPU, memory, bandwidth) and disrupting the topology.

Industry vertical: This information may include an industry category (e.g., energy, healthcare, banking, etc.) where a given organization operates. Industry vertical information may be relevant when selecting relevant network traffic flows to be replicated. Industry vertical details may introduce specific considerations based on their respective industries. For example, in the energy sector, relevant network traffic flows may include flows that involve monitoring power systems for anomalies. In healthcare, relevant traffic flows may include secured patient data. In banking, relevant flows may be related to preventing fraud and securing financial data. There may also be regulations, and security concerns associated with each industry. Such verticalized training definitions may be updated on a regular basis. Specialized IoT traffic (perhaps sporadic) may be produced in any one of these industries.

Network contextual information: This information may include user types, device type, location, application, or service being used, and this information may be provided by a system or network operator.

Applications being used: This information may comprise a list of applications being used in the organization and business relevance for each such application.

Network location: This information may include whether the physical network 110 supports, e.g., a corporate office, data center, or residential area. This information may provide insights into the expected types of traffic. For example, a corporate network may have a higher likelihood of containing business-related traffic such as emails, file transfers, and video conferencing.

Size of the network: This information may detail whether physical network 110 is, e.g., a small local network or a large enterprise network. This information may give indications to model 250 about the expected traffic types. Larger networks may have more diverse traffic, including varied applications and services.

Time of day: This indicates when data capture is performed. For example, during working hours, there may be more business-related traffic, while during evenings and weekends, there may be more leisure-related or personal traffic.

Historical data: Historical data may provide valuable information about the types of traffic that have been observed in the past. This data may help model 250 identify the relevant traffic flows when data capture is performed.

Network policies and configurations: This information may detail any relevant configurations and/or restrictions that may be in place. This information may give insights into the types of traffic that are allowed or blocked. For example, if certain applications or services are prohibited, it can influence the expected traffic flow.

By training model 250 using training data 220, replication logic 200 may be configured to that the “top talker” or “talkers” in the physical network 110 is not simply being mirrored, but the entropy of network communications, including “one off,” sporadic, or rarely observed data patterns, have an opportunity to be transmitted to digital twin 120.

In an embodiment federated learning techniques may be applied in model 250 to scale out and assess common patterns in more national/global environments.

In addition to the more automated AI/ML driven traffic replication decisions, replication logic 200 may be configured to enable the tester/operator/user the flexibility to dial up/down the traffic level replicated to digital twin 120, based on configurable parameters. This provides the ability to customize replication according to desired testing for a given environment.

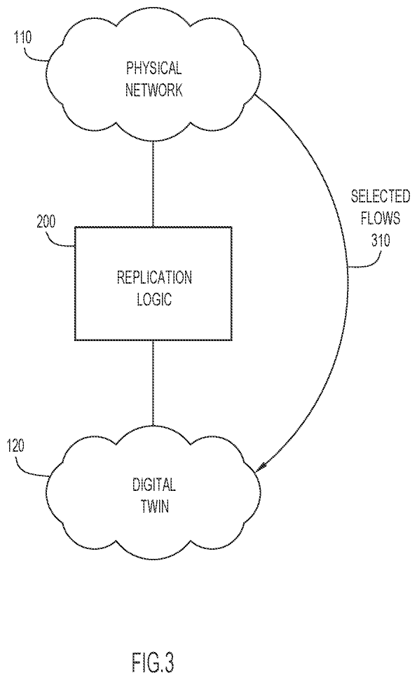

FIG. 3 shows how selected flows 310 are replicated and passed to digital twin 120 according to an example embodiment. As noted, the volume of selected flows 310 may be on the order of 2% (ratio 1:50) of the actual traffic flowing through physical network 110.

The solution described herein has the ability to harvest and save the selected flows for later reuse in the testing environment, enabling use cases such as running tests during hours when live traffic may not be present, or replaying the same traffic flows with different network configuration constraints or options. Users and organizations can build libraries of business relevant traffic flow collections which can be used on-demand in digital twin 120.

Unlike some solutions that indiscriminately send EMIX or IMIX traffic through a digital twin, the present embodiments are configured to select and replicate real traffic that aligns with the daily changes observed in organizations. Unique to this system is the ability to tailor the desired amount of bandwidth and traffic to be replicated in real-time and sent to digital twin 120 based on the digital twin profile which was created.

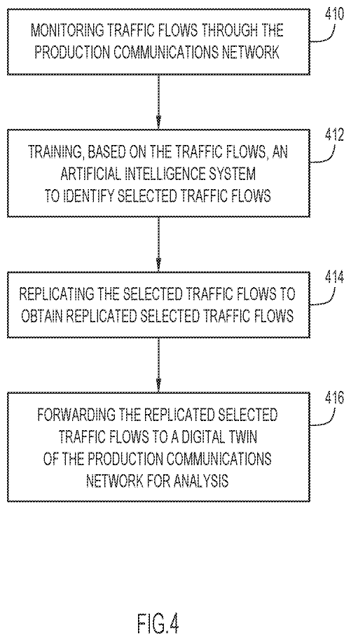

FIG. 4 is a flowchart illustrating a series of operations that may be executed by replication logic and/or related functions or components, according to an example embodiment. At 410, an operation includes monitoring traffic flows through the production communications network. At 412, an operation includes training, based on the traffic flows, an artificial intelligence system to identify selected traffic flows. At 414, an operation includes replicating the selected traffic flows to obtain replicated selected traffic flows. And, at 416, an operation includes forwarding the replicated selected traffic flows to a digital twin of the production communications network for analysis.

FIG. 5 is a block diagram of a computing device that may be configured to execute replication logic 200 and perform the techniques described herein, according to an example embodiment. In various embodiments, a computing device, such as computing device 500 or any combination of computing devices 500, may be configured as any entity/entities as discussed for the techniques depicted in connection with FIGS. 1-4 in order to perform operations of the various techniques discussed herein. Those skilled in the art will appreciate that replication logic 200 could also be executed in a virtual environment.

In at least one embodiment, the computing device 500 may include one or more processor(s) 502, one or more memory element(s) 504, storage 506, a bus 508, one or more network processor unit(s) 510 interconnected with one or more network input/output (I/O) interface(s) 512, one or more I/O interface(s) 514, and control logic 520 (which could include, for example, replication logic 200. In various embodiments, instructions associated with logic for computing device 500 can overlap in any manner and are not limited to the specific allocation of instructions and/or operations described herein.

In at least one embodiment, processor(s) 502 is/are at least one hardware processor configured to execute various tasks, operations and/or functions for computing device 500 as described herein according to software and/or instructions configured for computing device 500. Processor(s) 502 (e.g., a hardware processor) can execute any type of instructions associated with data to achieve the operations detailed herein. In one example, processor(s) 502 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 504 and/or storage 506 is/are configured to store data, information, software, and/or instructions associated with computing device 500, and/or logic configured for memory element(s) 504 and/or storage 506. For example, any logic described herein (e.g., control logic 520) can, in various embodiments, be stored for computing device 500 using any combination of memory element(s) 504 and/or storage 506. Note that in some embodiments, storage 506 can be consolidated with memory element(s) 504 (or vice versa) or can overlap/exist in any other suitable manner.

In at least one embodiment, bus 508 can be configured as an interface that enables one or more elements of computing device 500 to communicate in order to exchange information and/or data. Bus 508 can be implemented with any architecture designed for passing control, data and/or information between processors, memory elements/storage, peripheral devices, and/or any other hardware and/or software components that may be configured for computing device 500. In at least one embodiment, bus 508 may be implemented as a fast kernel-hosted interconnect, potentially using shared memory between processes (e.g., logic), which can enable efficient communication paths between the processes.

In various embodiments, network processor unit(s) 510 may enable communication between computing device 500 and other systems, entities, etc., via network I/O interface(s) 512 (wired and/or wireless) to facilitate operations discussed for various embodiments described herein. In various embodiments, network processor unit(s) 510 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 500 and other systems, entities, etc. to facilitate operations for various embodiments described herein. In various embodiments, network I/O interface(s) 512 can be configured as one or more Ethernet port(s), Fibre Channel ports, any other I/O port(s), and/or antenna(s)/antenna array(s) now known or hereafter developed. Thus, the network processor unit(s) 510 and/or network I/O interface(s) 512 may include suitable interfaces for receiving, transmitting, and/or otherwise communicating data and/or information in a network environment.

I/O interface(s) 514 allow for input and output of data and/or information with other entities that may be connected to computing device 500. For example, I/O interface(s) 514 may provide a connection to external devices such as a keyboard, keypad, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

In various embodiments, control logic 520 can include instructions that, when executed, cause processor(s) 502 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 520) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, entities as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 504 and/or storage 506 can store data, software, code, instructions (e.g., processor instructions), logic, parameters, combinations thereof, and/or the like used for operations described herein. This includes memory element(s) 504 and/or storage 506 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses. Non-IP network traffic could also be processed by the methodology described herein.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

In sum, a method may include operating a production communications network, monitoring traffic flows through the production communications network, training, based on the traffic flows, an artificial intelligence system to identify selected traffic flows, replicating the selected traffic flows to obtain replicated selected traffic flows, and forwarding the replicated selected traffic flows to a digital twin of the production communications network for analysis.

The method may further include training the artificial intelligence system based on a profile of the digital twin.

In the method, the profile of the digital twin may include information representative of at least one of memory capacity, processing power, or bandwidth of the digital twin.

The method may further include training the artificial intelligence system based on an industry to which the traffic flows pertain.

In the method, the industry may be one of energy, healthcare, or banking.

The method may further include training the artificial intelligence system based on applications supported by the traffic flows.

The method may further include training the artificial intelligence system based on a size of the production communications network.

The method may further include training the artificial intelligence system based on policies and configurations of the production communications network.

In the method, the digital twin may be software based.

In the method, the selected traffic flows may account for about 2% of the traffic flows.

In another embodiment, a device may be provided and may include an interface configured to enable network communications, a memory, and one or more processors coupled to the interface and the memory, and configured to: operate a production communications network, monitor traffic flows through the production communications network, train, based on the traffic flows, an artificial intelligence system to identify selected traffic flows, replicate the selected traffic flows to obtain replicated selected traffic flows, and forward the replicated selected traffic flows to a digital twin of the production communications network for analysis.

In the device, the one or more processors may be further configured to train the artificial intelligence system based on a profile of the digital twin.

In the device, the profile of the digital twin may include information representative of at least one of memory capacity, processing power, or bandwidth of the digital twin.

In the device, the one or more processors may be further configured to train the artificial intelligence system based on an industry to which the traffic flows pertain.

In the device, the industry may be one of energy, healthcare, or banking.

In the device, the one or more processors may be further configured to train the artificial intelligence system based on applications supported by the traffic flows.

In yet another embodiment, one or more non-transitory computer readable storage media encoded with instructions are provided and that, when executed by a processor, cause the processor to: operate a production communications network, monitor traffic flows through the production communications network, train, based on the traffic flows, an artificial intelligence system to identify selected traffic flows, replicate the selected traffic flows to obtain replicated selected traffic flows, and forward the replicated selected traffic flows to a digital twin of the production communications network for analysis.

In the one or more non-transitory computer readable storage media, the instructions may be configured to train the artificial intelligence system based on a profile of the digital twin.

In the one or more non-transitory computer readable storage media, the profile of the digital twin may include information representative of at least one of memory capacity, processing power, or bandwidth of the digital twin.

In the one or more non-transitory computer readable storage media, the instructions may be configured to train the artificial intelligence system based on an industry to which the traffic flows pertain.

Each example embodiment disclosed herein has been included to present one or more different features. However, all disclosed example embodiments are designed to work together as part of a single larger system or method. This disclosure explicitly envisions compound embodiments that combine multiple previously discussed features in different example embodiments into a single system or method.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

1. A method comprising:
operating a production communications network;
monitoring traffic flows through the production communications network;
training, based on the traffic flows through the production communications network, an artificial intelligence system to identify selected traffic flows;
replicating the selected traffic flows to obtain replicated selected traffic flows; and
forwarding the replicated selected traffic flows to a digital twin of the production communications network for analysis.

2. The method of claim 1, further comprising training the artificial intelligence system based on a profile of the digital twin.

3. The method of claim 2, wherein the profile of the digital twin comprises information representative of at least one of memory capacity, processing power, or bandwidth of the digital twin.

4. The method of claim 1, further comprising training the artificial intelligence system based on an industry to which the traffic flows pertain.

5. The method of claim 4, wherein the industry is one of energy, healthcare, or banking.

6. The method of claim 1, further comprising training the artificial intelligence system based on applications supported by the traffic flows.

7. The method of claim 1, further comprising training the artificial intelligence system based on a size of the production communications network.

8. The method of claim 1, further comprising training the artificial intelligence system based on policies and configurations of the production communications network.

9. The method of claim 1, wherein the digital twin is software based.

10. The method of claim 1, wherein the selected traffic flows comprise a subset of the traffic flows through the production communications network.

11. A device comprising:
an interface configured to enable network communications;
a memory; and
one or more processors coupled to the interface and the memory, and configured to:
operate a production communications network;
monitor traffic flows through the production communications network;
train, based on the traffic flows through the production communications network, an artificial intelligence system to identify selected traffic flows;
replicate the selected traffic flows to obtain replicated selected traffic flows; and
forward the replicated selected traffic flows to a digital twin of the production communications network for analysis.

12. The device of claim 11, wherein the one or more processors are further configured to train the artificial intelligence system based on a profile of the digital twin.

13. The device of claim 12, wherein the profile of the digital twin comprises information representative of at least one of memory capacity, processing power, or bandwidth of the digital twin.

14. The device of claim 11, wherein the one or more processors are further configured to train the artificial intelligence system based on an industry to which the traffic flows pertain.

15. The device of claim 14, wherein the industry is one of energy, healthcare, or banking.

16. The device of claim 11, wherein the one or more processors are further configured to train the artificial intelligence system based on applications supported by the traffic flows.

17. One or more non-transitory computer readable storage media encoded with instructions that, when executed by a processor, cause the processor to:
operate a production communications network;
monitor traffic flows through the production communications network;
train, based on the traffic flows through the production communications network, an artificial intelligence system to identify selected traffic flows;
replicate the selected traffic flows to obtain replicated selected traffic flows; and
forward the replicated selected traffic flows to a digital twin of the production communications network for analysis.

18. The one or more non-transitory computer readable storage media of claim 17, wherein the instructions are configured to train the artificial intelligence system based on a profile of the digital twin.

19. The one or more non-transitory computer readable storage media of claim 18, wherein the profile of the digital twin comprises information representative of at least one of memory capacity, processing power, or bandwidth of the digital twin.

20. The one or more non-transitory computer readable storage media of claim 17, wherein the instructions are configured to train the artificial intelligence system based on an industry to which the traffic flows pertain.
